(19) United States
(12) Patent Application Publication
(10) Pub. No.: US 2009/0211561 A1
(43) Pub. Date: Aug. 27, 2009

(54) Peep light release

(76) Inventor: Jeffrey Lynn McFatridge, Hillsboro, TX (US)

Correspondence Address: David G. Moore, Suite 205, 400 W. Oak St., Denton, TX, 76201, US

(21) Appl. No.: 12/380,155

(22) Filed: Feb. 24, 2009

Related U.S. Application Data
(60) Provisional application No. 61/067,200, filed on Feb. 26, 2008.

(51) Int. Cl. F41B 5/18; F21L 4/00

(52) U.S. Cl. 124/32; 124/35.2; 362/157

(57) ABSTRACT

The invention disclosed herein is a device which illuminates the rear peep sight attached to a bow string used by an archer when aiming an arrow at a target. The device which illuminates the rear peep sight attached to the bow string used by an archer to aim an arrow is a LED light with a battery power supply and on on/off switch attached to the arrow trigger release mechanism affixed to the archer's wrist by straps. During low light conditions the archer can conveniently illuminate the aperture of the rear peep sight with the LED light powered by the battery to enable the archer to visualize the aperture of the rear peep sight and properly aim the arrow toward the target.

### CROSS-REFERENCE TO RELATED APPLICATIONS

This application seeks priority to U.S. Provisional Patent Application No. 61/067,200 filed on Feb. 26, 2008.

### STATEMENT REGARDING FEDERALLY SPONSORED RESEARCH OR DEVELOPMENT

The invention disclosed herein was not the subject of any federally sponsored research or development.

### THE NAMES OF THE PARTIES TO A JOINT RESEARCH AGREEMENT

Not applicable.

### REFERENCE TO A SEQUENCE LISTING

Not applicable.

### BACKGROUND OF THE INVENTION

The use of a bow and arrow for hunting and protection has been practiced for many centuries. The bow and arrow were used to hunt game for food and skilled archers were some of the most feared soldiers on the battlefield. In its simplest form, the bow consists of a long stick made of wood with the ends connected by a string usually made of woven yarn. The archer's strength was used to pull the string back creating kinetic energy in the bow, which when released would send the arrow toward the target at a fairly high speed.

Today, the bow only vaguely resembles its ancestors used hundreds of years ago. The modern bow is typically made from lightweight, strong composite materials capable of storing enormous kinetic energy to propel the arrow in flight at high velocity and for long distance. The archer's muscular strength is magnified by the use of pulleys which enable the archer to transmit more kinetic energy to the bow when the bow string is pulled back. To enable the archer to grasp the arrow under such high kinetic energy conditions and to slow the development of fatigue in the archer's hand and fingers, specialized devices have been developed. One such device or arrow trigger release mechanism consists of a double caliper or grasping device which is connected by a spring or other means to a trigger similar to the trigger found on firearms. This device is attached to the archer's hand by a strap which is buckled or otherwise fastened around the archer's wrist. When the archer is ready to shoot an arrow, the bow string is fitted into a notch at the rear of the arrow with the front of the arrow resting on a platform attached to the center of the bow or sometimes the arrow may simply rest on the hand of the archer which is grasping the bow. The calipers affixed to the arrow trigger release mechanism are securely closed around that portion of the arrow into which the bow string has been inserted. The archer can then retract the bow string and when ready, pull the trigger on the arrow trigger release mechanism, opening the calipers and releasing the arrow to fly toward the target.

Aiming an arrow with precision is problematic. Various devices have been made to enable the archer to more accurately aim the arrow. One of those devices is a rear peep sight attached to a bow string. The rear peep sight attached to a bow string is a ring with an aperture in the center, which is inserted into the bow string at a location just above the place where the notch of the arrow comes into contact with the bow string. The archer on retracting the bow string and arrow can look through the aperture of the rear peep sight, identify the target and aim the arrow toward the target. In some cases front sights attached to the bow are employed. When front sights on the bow are used, the archer, looking through the aperture of the rear peep sight, aims the arrow at the target using both the front sight and the rear peep sight. When the rear peep sight attached to the bow string and front sight attached to the bow are aligned on the target, the archer can pull the trigger on the arrow trigger release mechanism releasing the arrow on a course to the target.

A problem with the use of the rear peep sight attached to the bow string occurs in low light conditions. In low light conditions, it is difficult for the archer to see through the aperture of the rear peep light and accurately aim the arrow at the target. This problem caused by low light conditions is especially acute during cloudy conditions or at dusk or dawn when the illumination from the sun is low. For a hunter in search of game, this problem caused by low light at dusk or dawn is especially problematic because dusk and dawn are usually an optimal time for hunting game. What is needed in the art is a device which can illuminate the rear peep sight and enable the archer to see through the aperture of the rear peep sight attached to the bow string and accurately aim the arrow toward the target.

### BRIEF SUMMARY OF THE INVENTION

The invention disclosed herein is a device which can illuminate the rear peep sight attached to a bow string and enable the archer to see through the aperture of the rear peep sight attached to the bow string and accurately aim the arrow toward the target. Specifically, the invention disclosed herein is a LED light, a power source for the LED light, and an activation switch to illuminate the LED light, all of which are attached to an arrow trigger release mechanism which is attached to the archer's wrist by a strap or other means. The LED light is attached to the arrow trigger release mechanism in such a manner as to illuminate the rear peep sight when activated by the archer. Activation of the LED light is by an on/off switch which can be activated by a thumb or finger of the archer's hand to which the arrow trigger release mechanism is attached. Power is supplied to the LED light by a small battery affixed to or housed within the arrow trigger release mechanism. Additionally, the LED light attached to the arrow trigger release mechanism may be tilted by as much as 45 degrees to provide optimal illumination of the rear peep sight attached to the bow string.

### BRIEF DESCRIPTION OF THE SEVERAL VIEWS OF THE DRAWINGS

A better understanding of the bow string peep sight light disclosed herein may be had by examination of the following figures.

FIG. 1. is a top view of the arrow trigger release mechanism with the LED light in the forward position on the body of the arrow trigger release mechanism.

FIG. 2. is a top view of the arrow trigger release mechanism with the LED light in the rear position on the body of the arrow trigger release mechanism.

FIG. 3. is a bottom view of the arrow trigger release mechanism with the LED light.

FIG. 4 is a side view of the arrow trigger release mechanism showing that the LED light can be tilted 45 degrees.

FIG. 5 is a front view of the arrow trigger release mechanism with LED light.

### DETAILED DESCRIPTION OF THE INVENTION

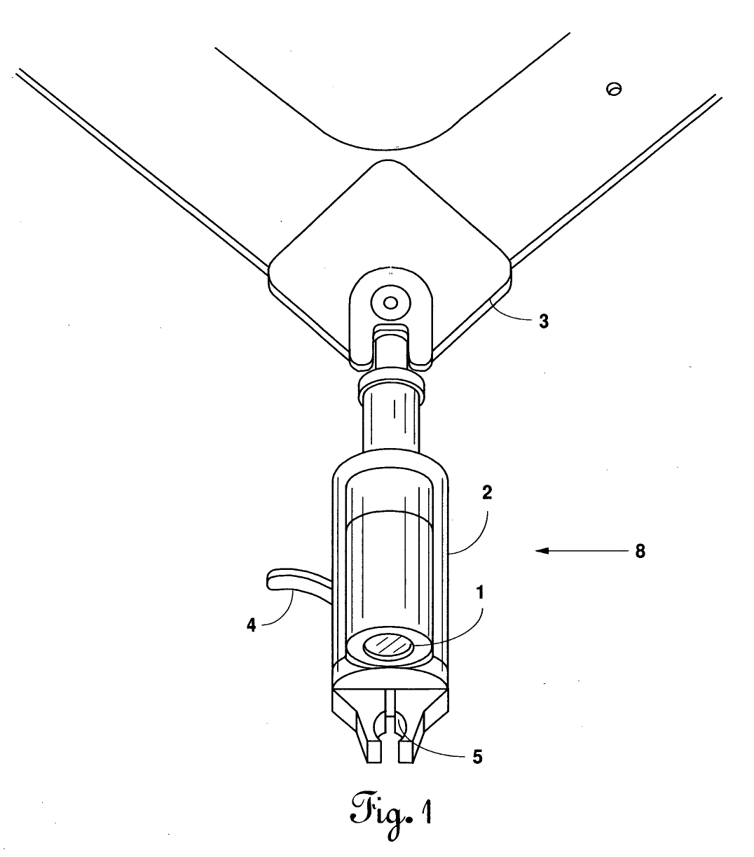

The invention disclosed herein solves the problem encountered by archers in attempting to aim an arrow at a target during low light conditions by using a peep sight attached to the bow string. The invention disclosed herein is an LED light attached to the arrow trigger release mechanism attached to the archer's wrist. The LED light is powered by a battery and activated by an on/off switch both of which are also attached to the arrow trigger release mechanism. The preferred embodiment of the invention disclosed herein is for the LED light to be located in a forward position on the body 2 of the arrow trigger release mechanism 8 as shown in FIG. 1. The LED lamp 1 is in the forward position on the body 2 of the arrow trigger release mechanism 8 for optimal illumination of the rear peep sight attached to the bow string and optionally, the front sight located on the bow. The battery which powers the LED light 1 is housed within the body 2 of the arrow trigger release mechanism 8. The arrow trigger release mechanism 8 is attached to the wrist of the archer by the straps 3 which firmly affix the arrow trigger release mechanism to the archer's wrist. The bow string and arrow are firmly held by the calipers 5 located in front of the LED light 1. When the archer is ready to release the arrow, the trigger 4 is pulled which opens the calipers 5 and the arrow is sent on its way.

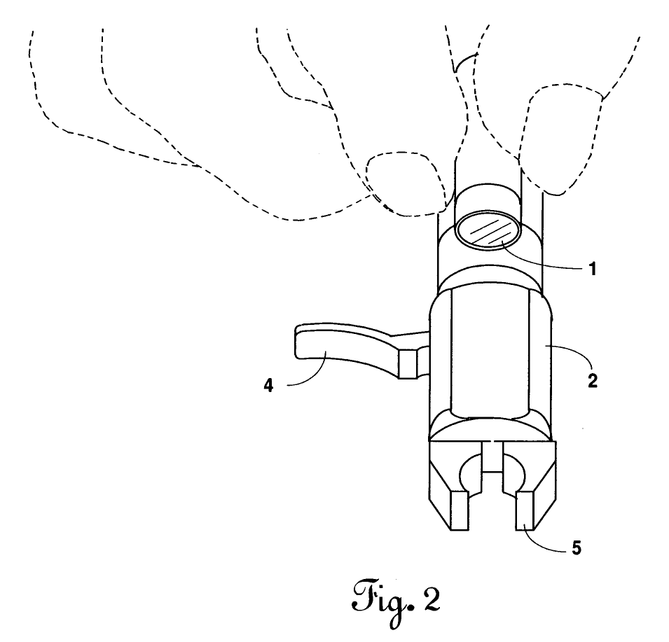

Another embodiment of the invention disclosed herein is shown in FIG. 2. In this embodiment, the LED light 1 is positioned and affixed to the rear of the body 2 of the arrow trigger release mechanism. The calipers 5 which hold the arrow firmly are shown in the open position

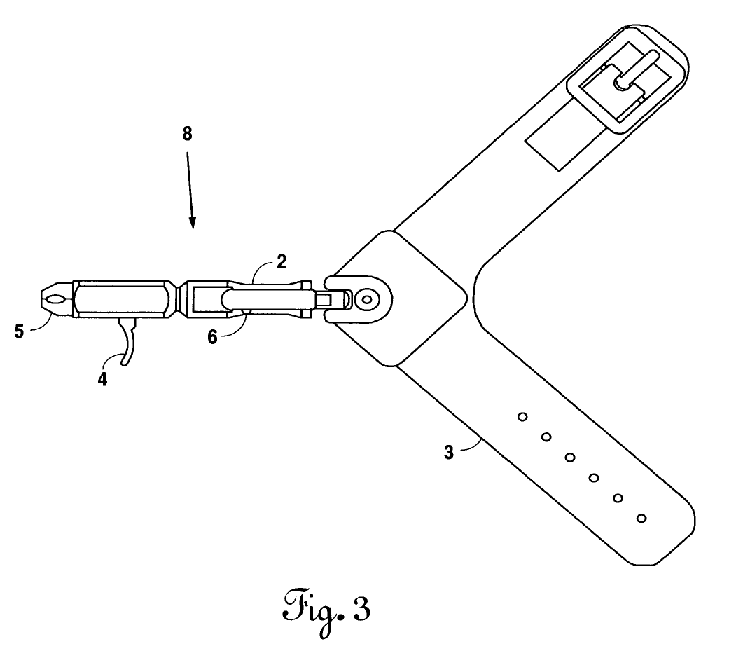

In FIG. 3, the on/off activator switch 6 for the LED light 1 is shown. Placement of the on/off activator switch 6 in this manner enables the archer to easily activate the LED light 1 and illuminate the rear peep sight attached to the bow string when the archer is ready to aim the arrow through the aperture of the rear peep sight. The battery is housed in the body 2 of the arrow trigger release mechanism 8 which is attached to the archer by adjustable straps 3. In FIG. 3 the calipers 5 which firmly hold the arrow, are shown in the closed position. When the archer is ready to fire the arrow, the trigger 4 is pulled which opens the calipers 5 and releases the arrow toward the target.

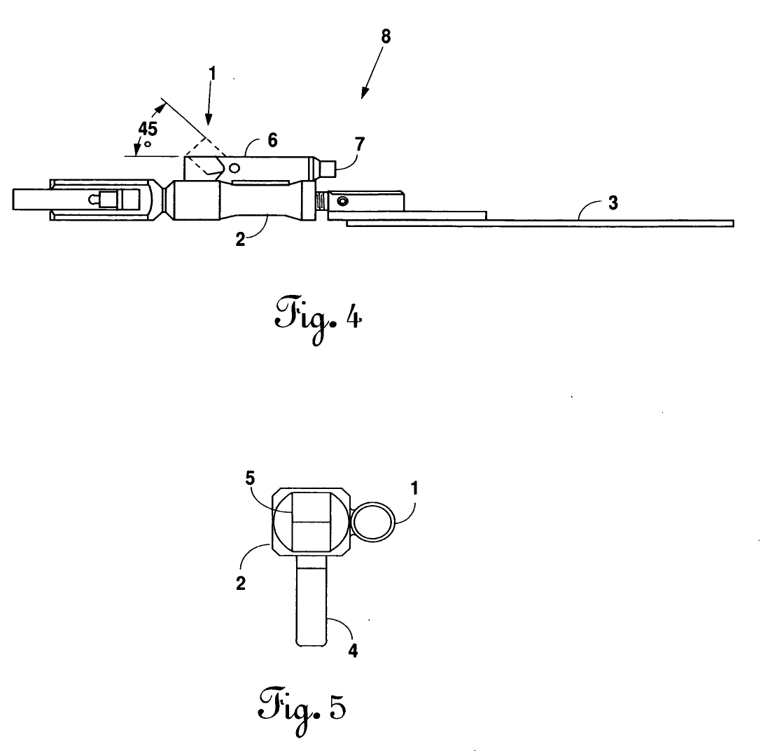

The LED light 1 is adjustable up to 45 degrees as shown in FIG. 4. This adjustability enables the archer to place to desired amount of illumination on the rear peep sight attached to the bow string for proper aiming. The access portal for the battery 7 is located to the rear of the body 2 of the arrow trigger release mechanism 8 enabling the archer to easily exchange the battery when the battery power is exhausted. The LED light on/off activation switch 6 is located on the body 2 of the arrow trigger release mechanism 8 for ease of activating the LED light 1 by the archer.

When the arrow trigger release mechanism is strapped to the archer's wrist as shown in FIG. 5, the LED light 1 is oriented to the side of the body 2 of the arrow trigger release mechanism 2 with the trigger 4 being oriented at the bottom of the body 2 of the arrow trigger release mechanism. In FIG. 5 the calipers 5 which securely hold the arrow are shown in the closed position.

The invention disclosed herein describes a device to illuminate the rear peep sight attached to the bow string for archery employing a LED light, a battery as a power source for the LED light and an on/off switch to activate the LED light and illuminate the rear peep sight attached to the bow string and optionally the front sight attached to the bow. The invention disclosed herein enables the archer to see the aperture of the rear peep sight and accurately aim the arrow at the target. It would be within the knowledge of one of ordinary skill in the art to include different types of light sources, different types of power sources for the light source and different types of on/off activation switches for the light sources. Further, it would be within the knowledge of one of ordinary skill in the art to recognize that the component parts of the invention disclosed herein could be arranged in a different manner than as disclosed herein. Those other alternatives are included within this disclosure to the extent that they are covered by the claims appended hereto.

I claim:

1. A device attached to an archer's arrow trigger release mechanism which illuminates the rear aiming sight attached to the bow string comprising:
A source of illumination;
A power supply for said source of illumination; and
A switch which activates or deactivates said source of illumination.
Thereby enabling the archer to visualize the rear aiming sight and accurately aim the arrow at a target during periods of decreased natural illumination.

2. The device attached to an archer's arrow trigger release mechanism which illuminates the rear aiming sight attached to the bow string as described in claim 1 wherein said source of illumination is a LED light.

3. The device attached to an archer's arrow trigger release mechanism which illuminates the rear aiming sight attached to the bow string as described in claim 1 wherein said power supply is a battery.

4. The device attached to an archer's arrow trigger release mechanism which illuminates the rear aiming sight attached to the bow string as described in claim 1 wherein said rear aiming sight is a peep sight.

5. A method for illuminating the aperture of a rear peep sight attached to a bow string during periods of low light comprising:
Aiming a source of illumination at said rear peep sight;
Providing power to said source of illumination; and
Activating the source of illumination with an on/off switch.
Thereby permitting the archer to visualize the aperture of said rear peep sight attached to the bow string and aims the arrow toward the target.

6. The method for illuminating the aperture of a rear peep sight attached to a bow string during periods of low light as described in claim 5 wherein said source of illumination is an LED light.

7. The method for illuminating the aperture of a rear peep sight attached to a bow string during periods of low light as described in claim 5 wherein said power is obtained from a battery.

8. A source of illumination attached to an archer's trigger release mechanism which illuminates the rear peep sight attached to a bow string comprising:
A LED light;
A battery; and
An on/off activation switch for the said LED light.
Thereby enabling the archer to see the aperture of the rear peep sight and aim the arrow at the target during periods of low light.

9. A source of illumination attached to an archer's trigger release mechanism which illuminates the rear peep sight attached to a bow string comprising:
A source of illumination;
A source of power;
An on/off activation switch for said source of illumination.
Thereby enabling the archer to see the aperture of the rear peep sight attached to the bow string and aim the arrow at the target during periods of low light.

10. The source of illumination attached to an archer's trigger release mechanism which illuminates the rear peep sight attached to the bow string as defined in claim 9 wherein said source of illumination is a LED light.

11. The source of illumination attached to an archer's trigger release mechanism which illuminates the rear peep sight attached to the bow string as defined in claim 9 wherein said source of power is a battery.
